(19) United States
(12) Patent Application Publication
(10) Pub. No.: US 2026/0271041 A1
(43) Pub. Date: Sep. 10, 2026

(54) BASE STATION

(71) Applicant: NTT DOCOMO, INC., Tokyo (JP)

(72) Inventor: Tianyang MIN, Tokyo (JP)

(73) Assignee: NTT DOCOMO, INC., Tokyo (JP)

(21) Appl. No.: 19/163,883

(22) PCT Filed: Mar. 31, 2023
(86) PCT No.: PCT/JP2023/013675

§ 371 Date: Sep. 10, 2025

(51) Int. Cl. H04W 72/51; H04W 36/38

(52) U.S. Cl. CPC H04W 72/51; H04W 36/38

(57) ABSTRACT

A base station includes: a transmission unit that transmits broadcasting information to a terminal, and a control unit that indicates a possibility of scheduling for a terminal having a smaller number of receiving antennas than another terminal in the broadcasting information.

### TECHNICAL FIELD

This disclosure relates to a base station that executes suitable scheduling according to the number of receiving antennas of a terminal.

### BACKGROUND ART

The 3rd Generation Partnership Project (3GPP) has specified the 5th generation mobile communication system (also referred to as 5G, New Radio (NR) or Next Generation (NG)), and is also in the process of specifying the next generation mobile communication system called Beyond 5G, 5G Evolution or 6G.

In Release 18, Extended Reality (XR) is discussed. In accepting XR, not only a conventional terminal (User Equipment, UE) but also a wearable device such as glasses are assumed to be used (Non-Patent Literature 1).

### CITATION LIST

### Non-Patent Literature

Non-Patent Literature 1:“Views on support of XR with 2Rx”, RP-230304, 3GPP TSG RAN Meeting #99, 3GPP, Mar. 20-23, 2023

### SUMMARY OF INVENTION

A wearable device has limited space to mount antennas for receiving radio signals compared to conventional UE. Therefore, while conventional UE has four receiving antennas (4RX), a wearable device is being considered to have less than four receiving antennas, for example, two receiving antennas (2RX). In the following, a terminal having four receiving antennas may be called 4RX UE. Similarly, a terminal with less than four receiving antennas may be called 2RX UE. That is, the number of receiving antennas of the 2RX UE is not limited to two, but may be one or three. The 2RX UE is not limited to a wearable device.

Due to a smaller number of antennas of the 2RX UE compared to the 4RX UE, the reception sensitivity of the 2vRX UE is lower. Therefore, the base station (gNodeB, gNB) needs to execute scheduling that is different from that for the 4RX UE in terms of a modulation coding scheme (MCS) and other aspects for the 2RX UE.

However, some gNBs do not assume scheduling for the 2RX UE. There is a risk that even such gNBs execute communication with the 2RX UE when random access is requested from the 2RX UE, because of not identifying the 2RX UE.

Therefore, the present disclosure has been made in view of such a situation, and an object of the present disclosure is to provide a base station capable of executing communication with the 2RX UE only when scheduling for the 2RX UE is assumed.

According to one embodiment of the disclosure, a base station includes: a transmission unit (transmission/reception unit 110) that transmits broadcasting information to a terminal, and a control unit (generation unit 120) that indicates a possibility of scheduling for a terminal having a smaller number of receiving antennas than another terminal in the broadcasting information.

### BRIEF DESCRIPTION OF THE DRAWINGS

FIG. 1 is an overall schematic configuration diagram of a radio communication system.

FIG. 2 is a diagram illustrating frequency ranges used in a radio communication system.

FIG. 3 is a diagram illustrating a configuration example of a radio frame, a sub-frame, a slot, and a symbol used in a radio communication system.

FIG. 4 is a functional block diagram of a base station.

FIG. 5 is a functional block diagram of a terminal.

FIG. 6 is a sequence diagram related to a possibility of scheduling transmitted to a terminal.

FIG. 7 is a sequence diagram related to a possibility of scheduling transmitted from another base station.

FIG. 8 is a sequence diagram related to a possibility of scheduling transmitted to a central unit.

FIG. 9 is a sequence diagram indicating that the number of receiving antennas is small in a random access procedure message.

FIG. 10 is a sequence diagram indicating that the number of receiving antennas is small in the capability information of a terminal.

FIG. 11 is a sequence diagram indicating that the number of receiving antennas is small in a core network.

FIG. 12 is a sequence diagram indicating that the number of receiving antennas is small in a central unit.

FIG. 13 is a diagram illustrating an example of a hardware configuration of a base station and a terminal.

FIG. 14 is a diagram illustrating an example of a configuration of a vehicle.

### DESCRIPTION OF EMBODIMENTS

Embodiments will be described below based on the drawings. The same functions and configurations are denoted by the same or similar reference signs, and their descriptions will be omitted, as appropriate.

### (1) Overall Schematic Configuration of Radio Communication System

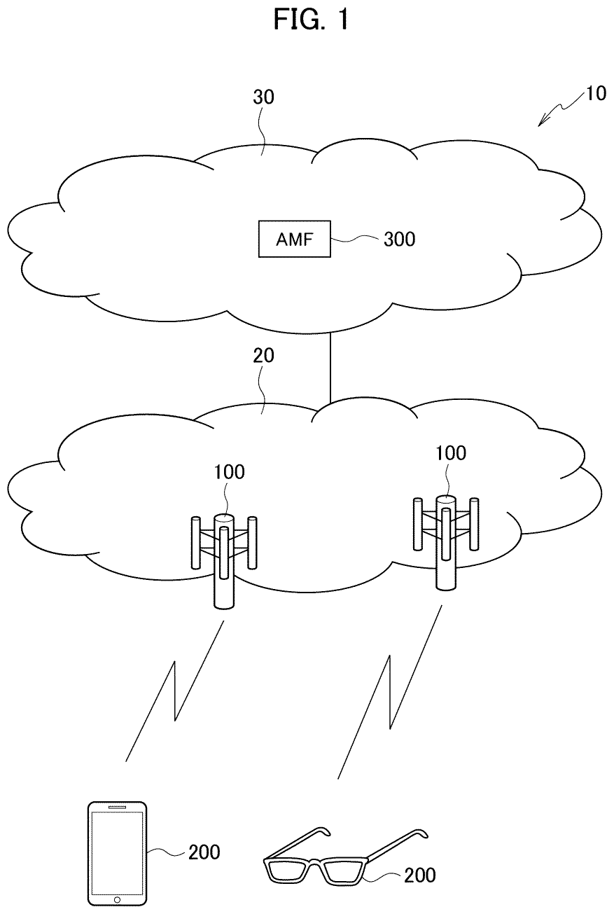

A radio communication system 10 illustrated in FIG. 1 is a radio communication system according to a system called 5G. However, the radio communication system 10 may be a radio communication system according to a system called Beyond 5G, 5G Evolution, or 6G.

The radio communication system 10 can support Massive Multiple-Input Multiple-Output (Massive MIMO), which generates a beam with higher directivity by controlling radio signals transmitted from a plurality of antenna elements, Carrier Aggregation (CA), which uses a plurality of component carriers (CC) bundled together, and Dual Connectivity (DC), which simultaneously communicates with two base stations.

As illustrated in FIG. 1, the radio communication system 10 includes a base station (gNodeB, gNB) 100 connected to a Next Generation-Radio Access Network (NG-RAN) 20, and a terminal (User Equipment, UE) 200 performing radio communication with gNB 100. The NG-RAN 20 is connected to a core network (CN) 30. The CN 30 is configured by a network function (NF) such as an Access and Mobility Management Function (AMF) 300. The specific configuration of the radio communication system 10, for example, the number of the gNBs 100 and the number of the UEs 200, is not limited to the example illustrated in FIG. 1. The NG-RAN 20 and CN 30 may be simply described as a network, and may or may not be interpreted to be included in the radio communication system 10.

The gNB 100 may be a base station of a Centralized-Radio Access Network (C-RAN) configuration having a distributed unit (DU) that is a function for connecting to the UE 200, and a central unit (CU) that is a function for connecting to a network. In this case, the gNB 100 may be read as a DU or a CU, but in the operation example described below, the gNB is mainly read as a DU. When the gNB 100 is a DU, it may be called a gNB-DU, an Integrated Access and Backhaul (IAB) node, a radio communication node, or the like. Similarly, when the gNB 100 are a CU, it may be called a gNB-CU, an IAB donor, or the like.

The UE 200 may be 4RX UE having four receiving antennas, or 2RX UE having fewer than four receiving antennas. However, in the operation example described below, it is assumed that the UE is mainly 2RX UE.

The UE 200 may be a wearable device such as glasses (see FIG. 1). The UE 200 may be a terminal capable of processing large amounts of data suitable for XR at high speed. In this case, the UE 200 may be referred to as an XR terminal, and if it is the 2RX UE, it may be referred to as a 2RX XR terminal.

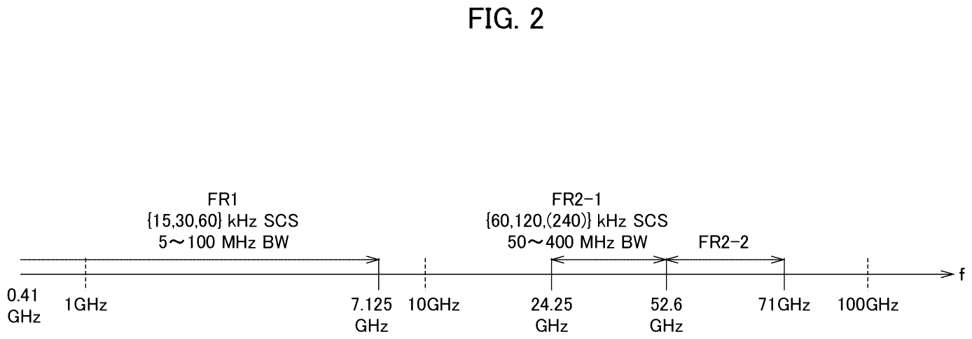

In addition, the radio communication system 10 may support multiple frequency ranges (FRs). That is, as illustrated in FIG. 2, it may support the following FRs.
FR1: 410 MHz to 7.125 GHZ
FR2-1: 24.25 GHz to 52.6 GHZ
FR2-2: over 52.6 GHz to 71 GHz

In FR1, a subcarrier interval (SCS) of 15, 30, or 60 kHz, and a bandwidth (BW) of 5 to 100 MHz may be used. In FR2-1, a SCS of 60 or 120 kHz (240 kHz may be included) and a BW of 50 to 400 MHz may be used.

In FR2-2, cyclic prefix-orthogonal frequency division multiplexing (CP-OFDM) or discrete Fourier transform-spread-orthogonal frequency division multiplexing (DFT-S-OFDM) with a larger SCS may be applied to avoid increasing phase noise.

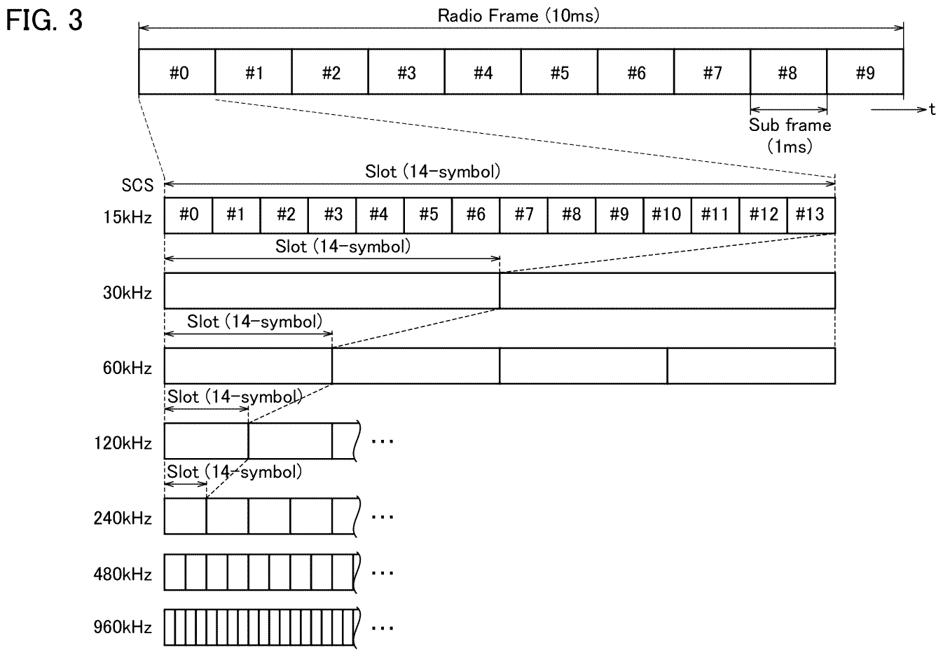

As illustrated in FIG. 3, one slot in the radio communication system 10 is constituted of 14 symbols. When this configuration is maintained, the larger (wider) the SCS, the shorter a symbol period (and a slot period). The SCS is not limited to the frequency illustrated in FIG. 3, and may be, for example, 480 kHz or 960 kHz.

The number of symbols constituting 1 slot need not be 14 symbols, but can be 28 or 56 symbols, for example. Furthermore, the number of slots per subframe may be different depending on the SCS.

### (2) Functional Block Configuration of Radio Communication System

### (2.1) Functional Block Configuration of Base Station

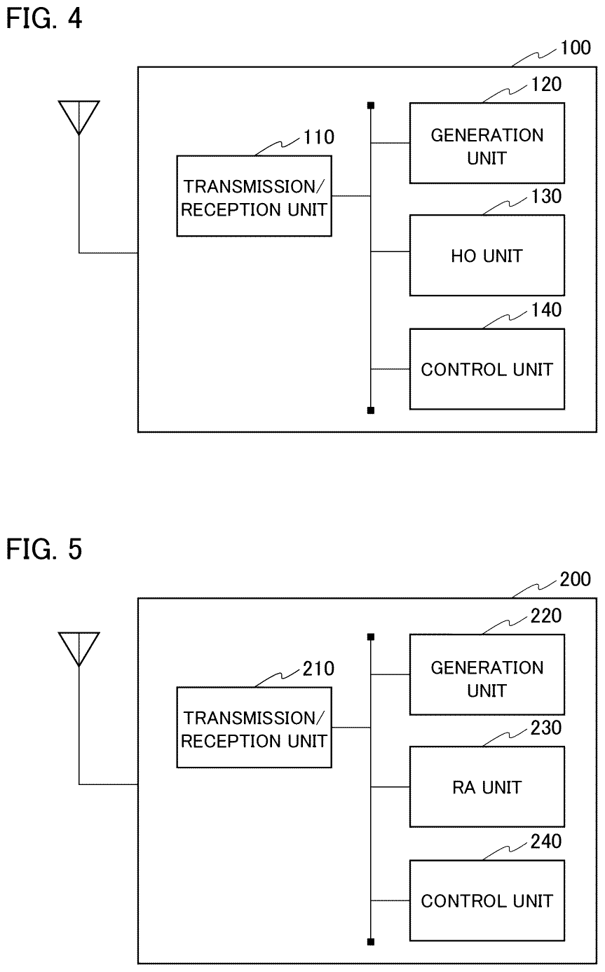

As illustrated in FIG. 4, the gNB 100 includes the transmission/reception unit 110, the generation unit 120, an HO unit 130, and a control unit 140.

The transmission/reception unit 110 transmits and receives radio signals to and from the UE 200. The transmission/reception unit 110 may include a transmission unit that transmits radio signals to the UE 200 or another gNB 100, and a reception unit that receives radio signals from the UE 200 or another gNB 100. The radio signals include broadcasting information and a message generated by the generation unit 120.

The generation unit 120 generates broadcasting information and a message to be transmitted to the UE 200. The broadcasting information may be a system information block, such as System Information Block 1 (SIB1). The message may be a message related to handover of the UE 200 controlled by the HO unit 130, a message related to a random access procedure executed by the UE 200, or a message to be transmitted to a network side.

The generation unit 120 may indicate a possibility of scheduling for the 2RX UE in the broadcasting information and message. The possibility of scheduling for the 2RX UE may be read as a possibility of support for the 2RX UE.

The HO unit 130 controls handover of the UE 200 to another gNB 100 (or a candidate cell formed by the gNB 100). That is, the HO unit 130 executes or cancels the handover of the UE 200. The HO unit 130 may control the handover of the UE 200 based on an indication of the possibility of scheduling for the 2RX UE from another gNB 100. That is, the HO unit 130 may confirm the possibility of scheduling for the 2RX UE to another gNB 100 that is a handover destination before executing the handover of the UE 200.

The control unit 140 controls the gNB 100. The control unit 140 controls, for example, transmission and reception of radio signals by the transmission/reception unit 110, generation of broadcasting information and a message by the generator unit 120, and execution or cancellation of the handover of the UE 200 by the HO unit 130.

When the gNB 100 assumes scheduling for the 2RX UE, the control unit 140 may execute scheduling for the 2RX UE that is different from that for the 4RX UE. Specifically, different scheduling may be executed in terms of a modulation coding scheme (MCS), a transmission frequency, or the like.

### (2.2) Functional Block Configuration of Terminal

As illustrated in FIG. 5, the UE 200 includes a transmission/reception unit 210, a generation unit 220, an RA unit 230, and a control unit 240.

The transmission/reception unit 210 transmits and receives radio signals to and from the gNBs 100. The transmission/reception unit 210 may include a transmission unit that transmits radio signals to the gNBs 100, and a reception unit that receives radio signals from the gNBs 100. The radio signals include a message generated by the generation unit 220.

The generation unit 220 generates a message to be transmitted to the gNB 100. The message may be related to random access procedures executed by the RA unit 230. The generation unit 220 may indicate in a message that the UE 200 is the 2RX UE.

The generation unit 220 may indicate to the core network 30 via the gNB 100 that the UE 200 is the 2RX UE by transmitting to the gNB 100 a message indicating that the UE 200 is the 2RX UE. Similarly, the generation unit 220 may indicate to the CU via the gNB 100 (DU) that the UE 200 is the 2RX UE by transmitting to the gNB 100 (DU) a message indicating that the UE 200 is the 2RX UE.

The RA unit 230 executes a random access procedure with the gNB 100. Specifically, the RA unit 230 establishes communication with the gNB 100 through transmission of a message generated by the generation unit 220, and reception of a message generated by the generation unit 120 of the gNBs 100. The transmission and reception of various messages in the random access procedure will be described in the operation example discussed below.

The RA unit 230 may execute a random access procedure with the gNB 100 based on an indication of the possibility of scheduling for the 2RX UE from the gNB 100. That is, when UE 200 is the 2RX UE, the random access procedure may be executed with the gNB 100 after confirming that the gNB 100 assumes scheduling for the 2RX UE.

The control unit 240 controls UE 200. The control unit 240 controls, for example, transmission/reception of radio signals by transmission/reception unit 210, generation of a message by the generation unit 220, and execution of random access by the RA unit 230.

### (3) Operation of Radio Communication System

### (3.1) Problems

### (3.1.1) Problem 1

Some gNBs do not assume scheduling for the 2RX UE. There is a risk that even such gNBs execute communication with the 2RX UE when random access is requested from the 2RX UE, because of not identifying the 2RX UE.

### (3.1.2) Problem 2

Some gNBs do not assume scheduling for the 2RX UE. For such gNBs, there is a risk of executing 2RX UE handover.

### (3.1.3) Problem 3

Some gNBs (DUs) do not assume scheduling for the 2RX UE. There is a risk that the CU perform control to execute communication with the 2RX UE even for such gNBs (DUs).

### (3.1.4) Problem 4

Even if random access is requested by the UE, the gNB cannot identify whether the UE is the 2RX UE or not. Therefore, even after the random access procedure is completed, there is a risk that inappropriate scheduling for the 2RX UE is executed.

### (3.1.5) Problem 5

In Problem 4, there is a problem that even if random access is requested by the UE, the AMF cannot identify whether the UE is the 2RX UE or not.

### (3.1.6) Problem 6

In Problem 4, when the gNB is a DU, there is a problem that even if random access is requested by the UE, the CU cannot identify whether the UE is the 2RX UE or not.

### (3.2) Operation Examples

### (3.2.1) Operation Example 1

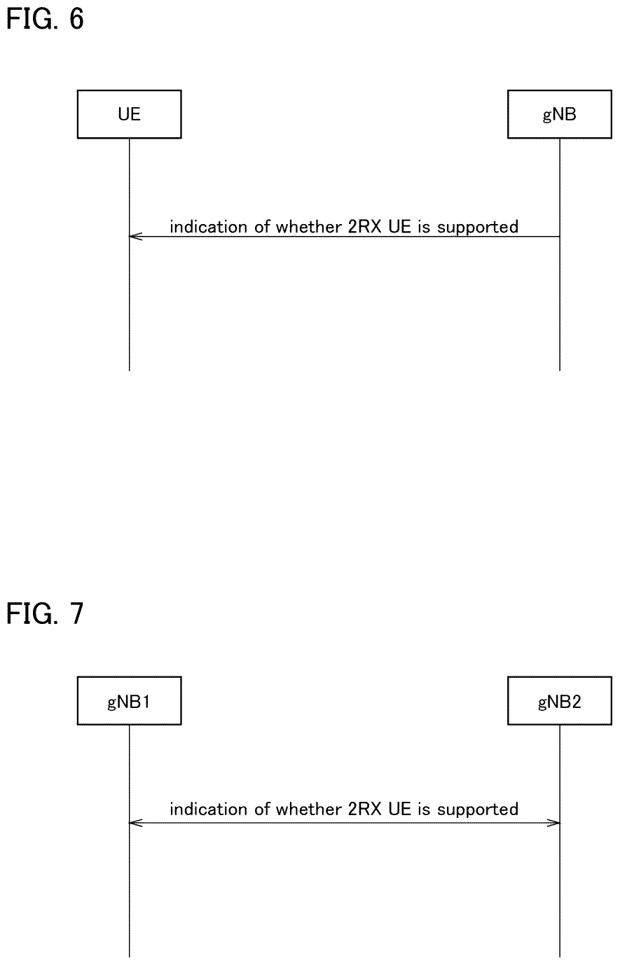

As illustrated in FIG. 6, the gNBs 100 can indicate to the UE 200 regarding the possibility of scheduling for the 2RX UE. This indication may be called a barring indication since the possibility of scheduling is indicated.

This indication may be an IE (or an indication in the IE) as follows.
cellBarredTwoRX-XR-UE ENUMERATED {barred, not barred}

Furthermore, this indication may be regarding the possibility of scheduling for Reduced Capability UE (RedCap UE). In other words, the indication of the possibility of scheduling for the RedCap UE may be reused. An indication of the possibility of scheduling for RedCap UE is, for example, cellBarredRedCap2Rx (barred, not barred) in SIB1.

Note that RedCap UE means UE having a limited capability. Specifically, the RedCap UE may mean a terminal whose corresponding bandwidth is narrower than that of conventional UE (for example, up to 20 MHz).

Furthermore, the IEs may be included in the broadcasting information. The broadcasting information may be a system information block such as SIB1. That is, the gNB 100 may indicate the possibility of scheduling for the 2RX UE in the broadcasting information.

As described above, the gNB 100 may indicate the possibility of scheduling for the 2RX UE in the broadcasting information. As a result, the UE 200 can request random access only to the gNBs 100 that assume the scheduling for the 2RX UE, so that the gNBs 100 that do not assume the scheduling for the 2RX UE can avoid a possibility of erroneously executing communication with the 2RX UE.

Furthermore, the gNB 100 can reuse the indication of a possibility of scheduling for the RedCap UE, and indicate a possibility of scheduling for the 2RX UE. As a result, it is not required to configure the IE newly, so that a load on the gNB 100 can be reduced.

### (3.2.2) Operation Example 2

As illustrated in FIG. 7, the gNB 100 can receive an indication of a possibility of scheduling for the 2RX UE in another gNB 100 from another gNB 100. In the following description, it is assumed that another gNB 100 is a base station that forms a candidate cell for handover of the UE 200. It should be noted that any of gNB1 and gNB2 in the drawings may be another gNB 100 that transmits an indication of a possibility of scheduling for the 2RX UE, and any of them may be the gNB 100 that receives the indication.

The indication of the possibility of scheduling for the 2RX UE may be an IE such as Served Cell Information NR IE (or an indication in the IE). The indication of the possibility of scheduling for the 2RX UE may be received in the Xn interface. The Served Cell Information NR IE may be included in a configuration request message such as an Xn setup request message, or in a configuration change message such as an NG-RAN NODE CONFIGURATION UPDATE message.

The gNB 100 receives an indication of the possibility of scheduling for the 2RX UE, and controls handover of the UE 200 as the 2RX UE based on the indication. That is, when an indication to the effect that scheduling for the 2RX UE is possible is received from another gNB 100, the handover is executed, and when an indication to the effect that scheduling for the 2RX UE is not possible is received from another gNB 100, the handover is canceled.

As described above, when executing the handover of the UE 200 as the 2RX UE, the gNB 100 can recognize whether another gNB 100 can execute scheduling for the 2RX UE. Thus, the gNB 100 can avoid the possibility of executing the handover to the gNB that does not assume scheduling for the 2RX UE.

### (3.2.3) Operation Example 3

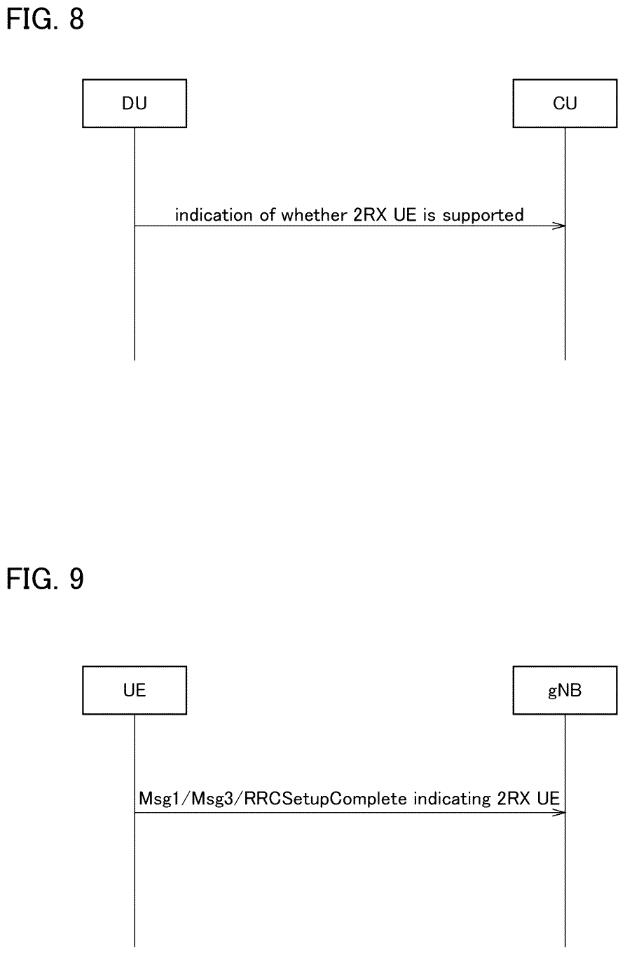

As illustrated in FIG. 8, when the gNB 100 is a distributed unit (DU), it can indicate to a central unit (CU) the possibility of scheduling for the 2RX UE.

The indication of the possibility of scheduling for the 2RX UE may be an IE such as Served Cell Information (or an indication in the IE). The indication of the possibility of scheduling for the 2RX UE may be transmitted in an F1 AP interface. The Served Cell Information may be included in a configuration request message such as an F1 SETUP REQUEST message, or may be included in a configuration change message such as a GNB-DU CONFIGURATION UPDATE message.

As described above, the gNB 100 (DU) can indicate to the CU the possibility of scheduling for the 2RX UE. As a result, the CU can recognize which gNB 100 (DU) assumes scheduling for the 2RX UE, thereby avoiding the possibility of controlling the gNB 100 (DU), which does not assume scheduling for the 2RX UE, to execute communication with the 2RX UE erroneously.

### (3.2.4) Operation Example 4

As illustrated in FIG. 9, the UE 200 executes a random access procedure to gNB 100. Here, the random access procedure will be briefly described.

First, when starting the random access procedure, UE 200 transmits a physical random access channel (PRACH) in a RACH resource configured by gNB 100 (corresponding to Msg1 in the drawing). The PRACH may be read as a preamble. Second, the UE 200 receives a physical downlink shared channel (PDSCH) as a random access response (RAR) (not illustrated). Third, the UE 200 transmits a PUSCH as an RRC connection request message (corresponding to Msg3 in the drawing). Fourth, the UE 200 receives a PDSCH as a contention resolution message (not illustrated). Finally, the UE 200 transmits an RRC setup completion message (corresponding to RRCSetupComplete in the drawing). The RRC setting completion message may be called Msg5 or a message indicating completion of the random access procedure.

In these messages (Msg1/Msg3/RRCSetupComplete), the UE 200 may indicate that the UE 200 is the 2RX UE (an indication that the UE 200 is the 2RX UE is included). The indications in each of the messages will be specifically described below.

When indicating in the Msg1, the UE 200 indicates that the UE 200 is the 2RX UE by transmitting a preamble in the RACH resource dedicated to the 2RX UE. The preamble is transmitted in the RACH resource dedicated to the 2RX UE, so that the gNB 100 can identify that the UE 200 transmitting the preamble is the 2RX UE. Note that the RACH resource dedicated to the 2RX UE may be broadcast by broadcasting information transmitted by the gNB 100.

When indicating in Msg3, the UE 200 indicates that the UE 200 is the 2RX UE by a code point of a logical channel identifier (for example, LCID for UL-SCH) included in the Msg3. In this case, the code point indicating that the UE 200 is the 2RX UE (or not the 2RX UE) may be newly introduced. The gNB 100 can identify from the code point included in the Msg3 that the UE 200 transmitting the Msg3 is the 2RX UE.

When indicating in Msg5, the UE 200 includes in the Msg5 an indication that the UE 200 is the 2RX UE. The gNB 100 can identify that the UE 200 transmitting the Msg5 is the 2RX UE, by the indication that the UE 200 is the 2RX UE included in the Msg5.

As described above, the UE 200 can transmit a message indicating that UE 200 is the 2RX UE in the random access procedure. As a result, the gNB 100 can recognize that the UE 200 executing the random access procedure is the 2RX UE in the random access procedure, and can execute appropriate scheduling for the 2RX UE after the random access procedure is completed.

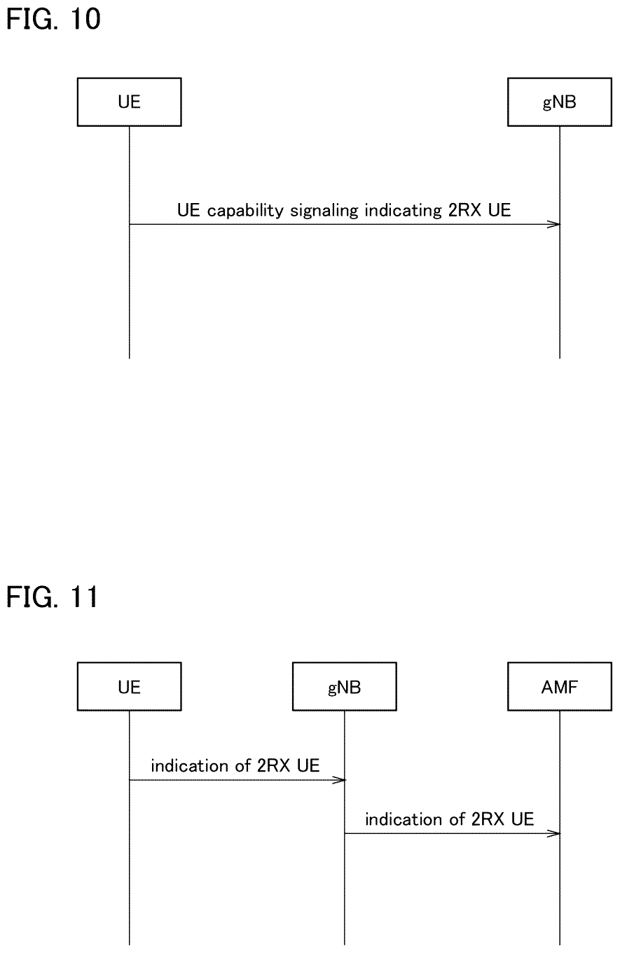

Further, as illustrated in FIG. 10, the UE 200 may transmit to the gNB 100 a UE capability signaling indicating that the UE 200 is the 2RX UE. This allows the gNBs 100 to execute appropriate scheduling for the 2RX UE, although only after the random access procedure is completed.

### (3.2.5) Operation Example 5

As described in Operation Example 4, the UE 200 can indicate to the gNB 100 that the UE 200 is the 2RX UE. Furthermore, as illustrated in FIG. 11, the gNB 100 may indicate to the core network 30 that the UE 200 is the 2RX UE. In other words, the UE 200 may indicate to the core network 30 via the gNB 100 that the UE 200 is the 2RX UE. Specifically, the UE 200 may indicate to the AMF 300 constituting the core network 30 that the UE 200 is the 2RX UE.

The indication from the gNB 100 to the core network 30 that the UE 200 is the 2RX UE may be executed in an NG-AP interface. Specifically, the indication that the UE 200 is the 2RX UE may be included in a message transmitted from the gNB 100 to the core network 30 (AMF 300), the message including an identifier of the UE 200 assigned by the gNB 100 (for example, INITIAL UE MESSAGE).

As described above, the UE 200 can indicate to the core network 30 (AMF 300) via the gNB 100 that the UE 200 is the 2RX UE. This allows the core network 30 (AMF 300) to recognize that the UE 200 is the 2RX UE.

The 2RX UE (wearable device) often has a small battery capacity, so it is desirable to reduce power consumption. In this operation example, the AMF 300 identifies the 2RX UE, so that a paging DRX cycle (predetermined time interval for paging) can be configured longer than that for the conventional UE (4RX UE). Thus, the 2RX UE can obtain a power saving effect.

### (3.2.6) Operation Example 6

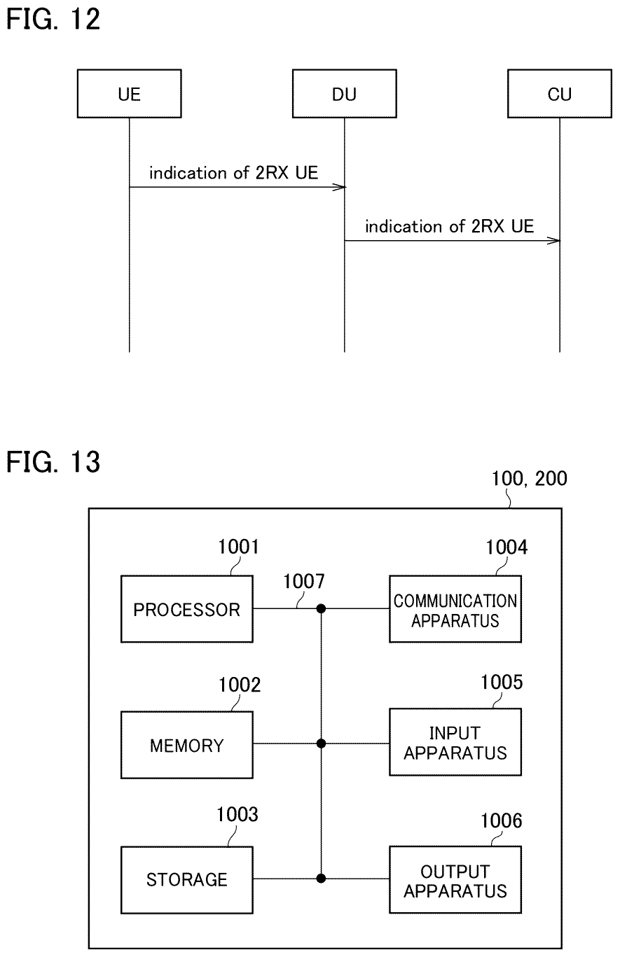

As described in Operation Example 4, the UE 200 can indicate to the gNB 100 that the UE 200 is the 2RX UE. Furthermore, as illustrated in FIG. 12, when the gNB 100 is a distributed unit (DU), it may indicate to the central unit (CU) that the UE 200 is the 2RX UE. In other words, the UE 200 may indicate to the CU via the gNB 100 (DU) that the UE 200 is the 2RX UE.

The indication from the gNB 100 (DU) to the CU that the UE 200 is the 2RX UE may be executed in the F1 AP interface. Specifically, the indication that the UE 200 is the 2RX UE may be included in a message transmitted from the gNB 100 (DU) to the CU, the message including a Cell-Radio Network Temporary Identifier (C-RNTI) assigned by the gNB 100 (DU) (for example, INITIAL UL RRC MESSAGE TRANSFER).

As described above, the UE 200 may indicate to the CU via the gNBs 100 (DU) that the UE 200 is the 2RX UE. Thus, the CU can recognize that the UE 200 is the 2RX UE.

The UE 200 may indicate to (notify) the CU (gNB-CU) in RRCSetupComplete or UE capability signaling that the UE 200 is the 2RX UE. In this case, the DU (gNB-DU) cannot recognize that the UE 200 is the 2RX UE (this is because contents of RRCSetupComplete and UE capability signaling are transparent to the DU). Therefore, the CU may indicate to (notify) the DU that the UE 200 is the 2RX UE.

### (4) Other Embodiments

The contents of the present invention have been described in accordance with the embodiments above. However, it is obvious to those skilled in the art that the present invention is not limited to the descriptions, and that various modifications and improvements can be made.

The disclosure above is not limited to the 2RX UE (when compared to the 4RX UE), but can be applied to a UE whose reception sensitivity is different from that of other UEs. For example, the disclosure above can be applied to a UE whose reception sensitivity is relatively low even if the number of reception antennas is the same. In addition, when, for example, 8RX UE equipped with 8 reception antennas (8RX) becomes popular in the future, the disclosure above can be applied to a UE that has a smaller number of receiving antennas (7or less reception antennas) than the 8RX UE.

The disclosure above may be applied to the 4RX UE, instead of the 2RX UE. For example, in an environment where a majority of UEs are 2RX UE, there may be a gNB 100 that does not assume scheduling for the 4RX UE. Such a gNB 100 may indicate the possibility of scheduling for the 4RX UE, and the UE 200 may indicate that the UE 200 is 4RX UE.

In the disclosure above, “configuration” may be understood to mean that a predetermined value or parameter is pre-configured, or that a value or parameter is configured by the gNB 100 or the UE 200.

In the disclosure above, “possibility” may be understood to mean that execution is possible or impossible, response is possible or impossible, or support is possible or impossible.

In the disclosure above, “base station” may be read as “node” or “cell.” In the handover, “(handover source) base station” may be read as “source base station” or “source cell,” and “(handover destination) base station” may be read as “target base station” or “target cell,” respectively.

In the disclosure above, the gNB 100 controls handover, and the UE 200 controls a random access procedure, without limitation thereto. The gNB 100 may control the random access procedure, and the UE 200 may control the handover. Either the gNB 100 or the UE 200 may control both the handover and the random access procedure, or both the gNB 100 and the UE 200 may cooperatively control both the handover and the random access procedure.

The above operation examples may be combined and applied in a complex manner as long as there is no conflict. For example, at least one of Operation Examples 1 to 3 and at least one of Operation Examples 4 to 6 may be combined.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

The block diagram (FIG. 4, FIG. 5) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but the functions are by no means limited to these. For example, a functional block (component) to implement a function of transmission may be referred to as a “transmitting section (transmitting unit),” a “transmitter”. The method for implementing each component is not particularly limited as described above.

Furthermore, the above-described gNB 100 and UE 200 (the apparatus) may function as a computer that executes the processes of the radio communication method of the present disclosure. FIG. 13 is a diagram to show an example of a hardware structure of the apparatus. As shown in FIG. 13, the apparatus may each be formed as a computer apparatus that includes a processor 1001, a memory 1002, a storage 1003, a communication apparatus 1004, an input apparatus 1005, an output apparatus 1006, a bus 1007, and so on.

Note that in the following description, the word such as an apparatus can be read as a circuit, a device, a section, a unit, and so on. The hardware structure of the apparatus may be configured to include one or more of apparatuses shown in the drawings, or may be configured not to include part of apparatuses.

Each function block (FIG. 4, FIG. 5) of the apparatus is implemented by one of hardware elements or the combination of the hardware elements in the computer apparatus.

Each function of the apparatus is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The above-described various processes may be performed by a single processor 1001, or may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and so on. The memory 1002 may be referred to as a “register,” a “cache,” a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of a compact disc (Compact Disc ROM (CD-ROM) and so on), a hard disk drive, a flexible disk, a magneto-optical disk (for example, a compact disc, a digital versatile disc, a Blu-ray (registered trademark) disk), a smart card, a flash memory device (for example, a card, a stick, and a key drive), a floppy (registered trademark) disk, a magnetic stripe, and so on. The storage 1003 may be referred to as “auxiliary storage apparatus.” The above recording medium may be a database including at least one of the memory 1002 and the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that performs output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, pieces of apparatus, including the processor 1001, the memory 1002, and others, are connected by a bus 1007 for communicating information. The bus 1007 may be formed with a single bus, or may be formed with buses that vary between pieces of apparatus.

Also, the apparatus may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information may be implemented by using physical layer signaling (for example, downlink control information (DCI), uplink control information (UCI)), higher layer signaling (for example, RRC signaling, Medium Access Control (MAC) signaling), broadcast information (master information block (MIB), system information block (SIB)), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), New radio access (NX), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Specific operations which have been described in the present disclosure to be performed by a base station may, in some cases, be performed by an upper node thereof. In a network including one or a plurality of network nodes with the base station, it is clear that various operations that are performed to communicate with a terminal can be 22 performed by the base station and other network nodes (for example, Mobility Management Entities (MMEs), Serving-Gateways (S-GWs), and so on may be possible, but these are not limiting) other than the base station, or combinations of these. According to the above, a case is described in which there is a single network node other than the base station. However, a combination of multiple other network nodes may be considered (e.g., MME and S-GW).

The information or signals may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A determination may be realized by a value (0 or 1) represented by one bit, by a boolean value (true or false), or by comparison of numerical values (e.g., comparison with a predetermined value).

Each aspect/embodiment described in the present disclosure may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

Software should be broadly interpreted to mean, regardless of whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies or wireless technologies is included within the definition of the transmission medium.

Information, a signal, or the like, described in the present disclosure may be represented by using any one of various different technologies. For example, data, an instruction, a command, information, a signal, a bit, a symbol, a chip, or the like, referred to throughout the above description, may be represented by a voltage, an electric current, electromagnetic waves, magnetic fields, a magnetic particle, optical fields, a photon, or a combination thereof.

It should be noted that a term described in the present disclosure and/or a term required for understanding of the present disclosure may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNodeB (eNB),” a “gNodeB (gNB),” an “access point,” a “transmission point,” a “reception point,” a “transmission/reception point,” a “cell,” a “sector,” a “cell group,” a “carrier,” a “component carrier,” and so on can be used interchangeably. A base station may be referred to as the terms such as a “macro cell,” a “small cell,” a “femto cell,” a “pico cell,” and so on.

A base station can accommodate one or a plurality of (for example, three) cells (which may be referred to as sectors). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases by the skilled person in the art.

At least one of a base station and a mobile station may be referred to as a “transmitting apparatus,” a “receiving apparatus,” a “communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, a base station in the present disclosure may be interpreted as a mobile station (user terminal, hereinafter the same). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, the mobile station may have the functions of the base station described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, a mobile station in the present disclosure may be interpreted as a base station. In this case, the base station may have the functions of the mobile station described above.

A radio frame may be constituted of one or a plurality of frames in the time domain. Each of one or a plurality of frames may be referred to as a “subframe” in the time domain.

Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of the number of symbols less than a slot. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may be a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of one or more wires, cables, and printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot”, depending on which standard is applied.

The phrase “based on” as used in the present disclosure does not mean “based only on”, unless otherwise specified. In other words, the phrase “based on” means both “based only on” and “based at least on”.

“Means” included in the configuration of each of the above apparatuses may be replaced by “parts”, “circuits”, “devices”, etc.

Reference to elements with designations such as “first,” “second,” and so on used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present disclosure is not intended to be an “exclusive or”.

In the present disclosure, in the case where an article is added by translation, for example “a”, “an”, and “the”, the disclosure may include that the noun following these articles is plural.

As used in the present disclosure, the term “determining” may encompasses a wide variety of actions. For example, “determining” may be regarded as determining to have performed judging, calculating, computing, processing, deriving, investigating, looking up (looking up, search, inquiry) (e.g., looking up in a table, a database or another data structure), ascertaining and the like. Also, “determining” may be regarded as determining to have performed receiving (e.g., receiving information), transmitting (e.g., transmitting information), inputting, outputting, accessing (e.g., accessing data in a memory) and the like. Also, “determining” may be regarded as determining to have performed resolving, selecting, choosing, establishing, comparing and the like. That is, “determining” may be regarded as determining to have performed some action. Moreover, “determining” may be read as “assuming”, “expecting”, “considering”, and the like.

In this disclosure, the term “A and B are different” may mean “A and B are different from each other.” It should be noted that the term “A and B are different” may mean “A and B are different from C.” Terms such as “separated” or “combined” may be interpreted in the same way as the “different”.

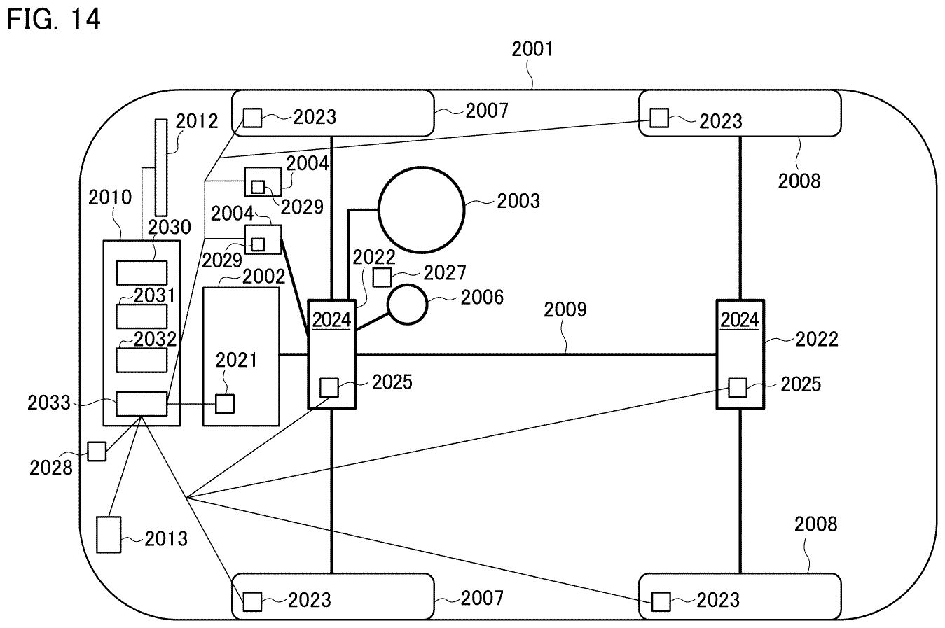

FIG. 14 shows an example of a configuration of a vehicle 2001. As shown in FIG. 14, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021-2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-29 provided in the vehicle. The electronic control unit 2010 may be referred to as an ECU (Electronic Control Unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and the sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal from a current sensor, which is input to the electronic control unit 2010, to external devices through radio communication. Also, the communication module 2013 transmits to external devices through radio communication, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like, which are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

As described above, the present disclosure has been described in detail. It is apparent to a person skilled in the art that the present disclosure is not limited to one or more embodiments described in the present disclosure. The present disclosure can be implemented as modifications and variations without departing from the subject matter and the scope of the present disclosure defined by the descriptions of claims. Therefore, the descriptions of the present disclosure are for illustrative purposes only, and are not intended to be any limitations to the present disclosure.

### Supplementary Notes

The above disclosure may be expressed as follows.

A first feature is a base station including a transmission unit that transmits broadcasting information to a terminal, and a control unit that indicates a possibility of scheduling for a terminal having a smaller number of receiving antennas than another terminal in the broadcasting information.

A second feature according to the first feature is the base station, in which the possibility of scheduling for the terminal is a possibility of scheduling for a terminal having a limited capability.

A third feature according to the first feature or the second feature is the base station including a reception unit that receives an indication of the possibility of scheduling for the terminal from another base station, and in which the control unit controls handover of the terminal to the other base station based on the indication from the other base station.

A fourth feature according to the third feature is the base station in which the indication from the other base station is included in a configuration request message or a configuration update message.

A fifth feature according to any one of the first to fourth features is the base station in which the transmission unit transmits an indication of the possibility of scheduling for the terminal to a central unit.

A sixth feature according to the fifth feature is the base station in which the indication to the central unit is included in a configuration request message or a configuration update message.

### REFERENCE SIGNS LIST

10 Radio communication system
20 NG-RAN
30 CN
100 gNB
110 Transmission/reception unit
120 Generation unit
130 HO unit
140 Control unit
200 UE
210 Transmission/reception unit
220 Generation unit
230 RA unit
240 Control unit
300 AMF
1001 Processor
1002 Memory
1003 Storage
1004 Communication apparatus
1005 Input apparatus
1006 Output apparatus
1007 Bus
2001 Vehicle
2002 Drive unit
2003 Steering unit
2004 Accelerator pedal
2005 Brake pedal
2006 Shift lever
2007 Right and left front wheels
2008 Right and left rear wheels
2009 Axle shaft
2010 Electronic control unit
2012 Information service unit
2013 Communication module
2021 Current sensor
2022 Rotation speed sensor
2023 Pneumatic sensor
2024 Vehicle speed sensor
2025 Acceleration sensor
2026 Brake pedal sensor
2027 Shift lever sensor
2028 Object detection sensor
2029 Axel pedal sensor
2030 Driving support system unit
2031 Microprocessor
2032 Memory (ROM, RAM)
2033 Communication port

1. A base station comprising:
a transmission unit that transmits broadcasting information to a terminal, and a control unit that indicates a possibility of scheduling for a terminal having a smaller number of receiving antennas than another terminal in the broadcasting information.

2. The base station according to claim 1, wherein the possibility of scheduling for the terminal is a possibility of scheduling for a terminal having a limited capability.

3. The base station according to claim 1, comprising a reception unit that receives an indication of the possibility of scheduling for the terminal from another base station, wherein
the control unit controls handover of the terminal to the other base station based on the indication from the other base station.

4. The base station according to claim 3, wherein the indication from the other base station is included in a configuration request message or a configuration update message.

5. The base station according to claim 1, wherein the transmission unit transmits an indication of the possibility of scheduling for the terminal to a central unit.

6. The base station according to claim 5, wherein the indication to the central unit is included in a configuration request message or a configuration update message.
